(19) United States
(12) Patent Application Publication
(10) Pub. No.: US 2012/0086803 A1
(43) Pub. Date: Apr. 12, 2012

(54) METHOD AND SYSTEM FOR DISTANCE ESTIMATION USING PROJECTED SYMBOL SEQUENCES

(76) Inventors: Thomas G. Malzbender, Palo Alto, CA (US); Ron M. Reth, Haifa (IL); Erik Ordentlich, San Jose, CA (US)

(21) Appl. No.: 12/901,995

(22) Filed: Oct. 11, 2010

(51) Int. Cl. H04N 7/18; H04N 9/31; H04N 5/228

(52) U.S. Cl. 348/140; 348/222.1; 348/E05.031; 348/E09.025; 348/E07.085

(57) ABSTRACT

Certain examples of the present invention are directed to an image-recording device. The image-recording device includes an imaging component that records an image of an environment, a projection component that projects, into the environment, an (n,d) reliable M*-sequence of symbols, and a distance component. The distance component identifies j consecutive symbols reflected back to the imaging component from a surface in the environment, where j≧n, detects and corrects a misidentified symbol within the j consecutive symbols based on the minimum distance t of the (n,d) reliable M*-sequence, determines a first position of the j consecutive symbols with respect to the image, determines a second position of the j consecutive symbols in the M*-sequence of symbols, and determines, from the first and second position, a distance t from the surface to the imaging component.

### TECHNICAL FIELD

The present invention is related to electronic image recording and image processing and, in particular, to generation and use of projected symbol sequences in order to determine a distance from a surface to an imaging device.

### BACKGROUND

Various types of imaging and image-recording technologies, including various types of camera-obscura devices, recording of images on silver-coated plates, photographic film, and, more recently, charge-coupled device (“CCD”) and complementary metal-oxide-semiconductor (“CMOS”) image sensors, have evolved over many hundreds of years. While significant research and development efforts are being currently applied to the recording and processing of full three-dimensional images, the vast majority of imaging and image-recording applications continue to be directed to two-dimensional imaging and image recording. Great strides have been made in automated image processing and automated extraction of real-world, three-dimensional information from two-dimensional images. However, the lack of direct information, associated with features in two-dimensional images, regarding the distance of the corresponding surfaces and objects in the three-dimensional environment of the image-recording device from the image-recording device continues to present significant challenges for automated image processing of, and automated information extraction from, two-dimensional images.

Recently, projection of infrared-wavelength patterns into three-dimensional environments that are being imaged by cameras has been proposed to provide infrared labeling of recorded images that can be used, by image-processing systems, to compute the distance between the camera and objects being imaged by the camera or, in other words, to associate distance information with imaged objects and surfaces. The use of illumination patterns to provide distance information in two-dimensional images is referred to as “structured illumination”. Researchers and developers and manufacturers of imaging devices and systems are currently expending significant effort to develop commercial implementations of imaging systems that employ structured illumination to provide information, associated with positions within two-dimensional images, regarding the distance of corresponding three-dimensional objects and surfaces from the imaging devices and systems.

### BRIEF DESCRIPTION OF THE DRAWINGS

FIG. 1 illustrates image recording by a generalized camera.

FIG. 2 illustrates the image recorded by the camera, in FIG. 1, as it appears on the surface of an image detector facing towards the lens and imaged scene.

FIG. 3 illustrates a desired level of distance information for two-dimensional images that would facilitate many automated image-processing tasks.

FIG. 4 illustrates the structured illumination technique for associating distance information with a two-dimensional image.

FIG. 5 further illustrates the structured-illumination technique for associating distance information with a two-dimensional image.

FIG. 6 illustrates a portion of one row of symbols projected by a structured-illumination-based imaging apparatus.

FIG. 7 illustrates a process liar generating an M-sequence of order k following selection of a set of k feedback taps from the coefficients of a primitive polynomial over GF(2).

FIG. 8 illustrates the uniqueness property of the M-sequence with respect to all k-blocks extractable from the M-sequence.

FIG. 9 illustrates incorrect imaging of a projected symbol.

FIG. 10 illustrates the advantage of M*-sequences over traditional M-sequences, according to certain examples of the present invention, when used in rows of symbols in projection planes of structured-illumination-based imaging devices and systems.

FIGS. 11-13 illustrate one approach to generating an M*-sequence with a desired n-block length n and desired minimum Hamming distance d according to one example of the present invention.

FIG. 14 illustrates one imaging-system example of the present invention.

FIG. 15 illustrates a generalized computer architecture for a computer system that, when controlled by a program to generate M*-sequences or to decode n-blocks of M*-sequences recognized in recorded images, and that represents one example of the present invention.

### DETAILED DESCRIPTION

The following discussion includes two sections: (1) a first section that provides an overview of error-control coding; and (2) a discussion of the present invention. Concepts from the field of error-control coding are employed in various examples of the present invention.

### Overview of Certain Aspects of Error-Control Encoding

Examples of the present invention employ concepts derived from well-known techniques in error-control encoding. An excellent reference for this field is the textbooks “Error Control Coding: Fundamentals and Applications,” Lin and Costello, Prentice-Hall, Incorporated, New Jersey, 1983 and “Introduction to Coding Theory,” Ron M. Roth, Cambridge University Press, 2006. In this subsection, a brief description of the error-detection and error-correction techniques used in error-control coding is provided. Additional details can be obtained from the above-referenced textbooks, or from many other textbooks, papers, and journal articles in this field. The current subsection represents a concise description of certain types of error-control encoding techniques.

Error-control encoding techniques systematically introduce supplemental bits or symbols into plain-text messages, or encode plain-text messages using a greater number of bits or symbols than absolutely required, in order to provide information in encoded messages to allow for errors arising in storage or transmission to be detected and, in some cases, corrected. One effect of the supplemental or more-than-absolutely-needed bits or symbols is to increase the distance between valid codewords, when codewords are viewed as vectors in a vector space and the distance between codewords is a metric derived from the vector subtraction of the codewords.

In describing error detection and correction, it is useful to describe the data to be transmitted, stored, and retrieved as one or more messages, where a message μ comprises an ordered sequence of symbols μ₁, that are elements of a field F. A message μ can be expressed as:

μ=(μ₀,μ₁, . . . μₖ₋₁)

where μ₁εF.
The field F is a set that is closed under multiplication and addition, and that includes multiplicative and additive inverses. It is common, in computational error detection and correction, to employ finite fields, GF(p^{m}), comprising all the m-tuples over the set of integers {0, 1, . . . , p−1} for a prime p, where the m-tuples are seen as polynomials of degree less than m over the field GF(p) of p elements comprising a subset of integers with size equal to the power m of a prime number p, with the addition and multiplication operators defined as addition and multiplication modulo an irreducible polynomial over GF(p) of degree m. In practice, the binary field GF(2) or a binary extension field GF(2^{m}) is commonly employed, and the following discussion assumes that the field GF(2) is employed. Commonly, the original message is encoded into a message c that also comprises an ordered sequence of elements of the field GF(2), expressed as follows:

c=(c₀,c₁, . . . cₙ₋₁)

where c₁εGF(2).

Block encoding techniques encode data in blocks. In this discussion, a block can be viewed as a message μ comprising a fixed number of k symbols that is encoded into a message c comprising an ordered sequence of n symbols. The encoded message c generally contains a greater number of symbols than the original message μ, and therefore n is greater than k. The r extra symbols in the encoded message, where r equals n−k, are used to carry redundant check information to allow for errors that arise during transmission, storage, and retrieval to be detected with an extremely high probability of detection and, in many cases, corrected.

In a linear block code, the 2^{k} codewords form a k-dimensional subspace of the vector space of all n-tuples over the field GF(2). The Hamming weight of a codeword is the number of non-zero elements in the codeword, and the Hamming distance between two codewords is the number of elements in which the two codewords differ. For example, consider the following two codewords a and b, assuming elements from the binary field:
a=(1 0 0 1 1)
b=(1 0 0 0 1)
   The codeword a has a Hamming weight of 3, the codeword b has a Hamming weight of 2, and the Hamming distance between codewords a and b is 1, since codewords a and b differ only in the fourth element. Linear block codes are often designated by a three-element tuple [n, k, d], where n is the codeword length, k is the message length, or, equivalently, the base-2 logarithm of the number of codewords, and d is the minimum Hamming distance between different codewords, equal to the minimal-Hamming-weight, non-zero codeword in the code.

The encoding of data for transmission, storage, and retrieval, and subsequent decoding of the encoded data, can be described as follows, when no errors arise during the transmission, storage, and retrieval of the data:

μ→c(s)→c(r)→μ

where c(s) is the encoded message prior to transmission, and c(r) is the initially retrieved or received, message. Thus, an initial message μ is encoded to produce encoded message c(s) which is then transmitted, stored, or transmitted and stored, and is then subsequently retrieved or received as initially received message c(r). When not corrupted, the initially received message c(r) is then decoded to produce the original message μ. As indicated above, when no errors arise, the originally encoded message c(s) is equal to the initially received message c(r), and the initially received message c(r) is straightforwardly decoded, without error correction, to the original message μ.

When errors arise during the transmission, storage, or retrieval of an encoded message, message encoding and decoding can be expressed as follows:

μ(s)→c(s)→c(r)→μ(r)

Thus, as stated above, the final message μ(r) may or may not be equal to the initial message μ(s), depending on the fidelity of the error detection and error correction techniques employed to encode the original message μ(s) and decode or reconstruct the initially received message c(r) to produce the final received message μ(r). Error detection is the process of determining that:

c(r)≠c(s)

while error correction is a process that reconstructs the initial, encoded message from a corrupted initially received message:

c(r)→c(s)

The encoding process is a process by which messages, symbolized as μ, are transformed into encoded messages c. Alternatively, a message μ can be considered to be a word comprising an ordered set of symbols from the alphabet consisting of elements of F, and the encoded messages c can be considered to be a codeword also comprising an ordered set of symbols from the alphabet of elements of F. A word μ can be any ordered combination of k symbols selected from the elements of F, while a codeword c is defined as an ordered sequence of n symbols selected from elements of F via the encoding process:

{c:μ→c}

Linear block encoding techniques encode words of length k by considering the word μ to be a vector in a k-dimensional vector space, and multiplying the vector μ by a generator matrix, as follows:

c=μ·G

Expanding the symbols in the above equation produces either of the following alternative expressions:

$$( {c}_{0} , {c}_{1} , … , {c}_{n - 1} ) = ( {μ}_{0} , {μ}_{1} , … , {μ}_{k - 1} ) ( \begin{matrix}{g}_{00} & {g}_{01} & {g}_{02} & … & {g}_{0 , n - 1} \\ & ⋮ & & ⋱ & ⋮ \\ {g}_{k - 1 , 0} & {g}_{k - 1 , 1} & {g}_{k - 1 , 2} & … & {g}_{k - 1 , n - 1}\end{matrix} )$$

$$( {c}_{0} , {c}_{1} , … , {c}_{n - 1} ) = ( {μ}_{0} , {μ}_{1} , … , {μ}_{k - 1} ) ( \begin{matrix}{g}_{0} \\ {g}_{1} \\ ⋮ \\ {g}_{k - 1}\end{matrix} )$$

where g₁(g_{i,0}, g_{i,1}, g_{i,2} . . . g_{i,n-1}).

The generator matrix G for a linear block code can have the form:

$${G}_{k , n} = ( \begin{matrix}{p}_{0 , 0} & {p}_{0 , 1} & … & {p}_{0 , r - 1} & 1 & 0 & 0 & … & 0 \\ {p}_{1 , 0} & {p}_{1 , 1} & … & {p}_{1 , r - 1} & 0 & 1 & 0 & … & 0 \\ … & … & … & & 0 & 0 & 1 & … & 0 \\ … & … & … & & … & … & … & … & … \\ … & … & … & & … & … & … & … & … \\ {p}_{k - 1 , 0} & {p}_{k - 1 , 1} & … & {p}_{k - 1 , r - 1} & 0 & 0 & 0 & … & 1\end{matrix} )$$

or, alternatively:

G_{k,n}=[P_{k,r}|I_{k,k}].

Thus, the generator matrix G can be placed into a form of a matrix P augmented with a k by k identity matrix I_{k,k}. Alternatively, the generator matrix G can have the form:

G_{k,n}=[I_{k,k}|P_{k,r}].

A code generated by a generator matrix in this form is referred to as a “systematic code.” When a generator matrix having the first form, above, is applied to a word μ, the resulting codeword c has the form:

c=(c₀,c₁, . . . ,c_{p, . . . 1},μ₀,μ₁, . . . ,μₖ₋₁

where c₁=μ₀p_{0,i}+μ₁p_{1,i}+ . . . +μₖ₋₁p_{k-1,i}. Using a generator matrix of the second form, codewords are generated with trailing parity-check bits. Thus, in a systematic linear block code, the codewords comprise r parity-check symbols c₁ followed by the k symbols comprising the comprising word μ or the k symbols comprising the original word μ followed by r parity-check symbols. When no errors arise, the original word, or message μ, occurs in clear-text form within, and is easily extracted from, the corresponding codeword. The parity-check symbols turn out to be linear combinations of the symbols of the original message, or word μ.

One form of a second, useful matrix is the parity-check matrix H_{r,n} defined as:

H_{r,n}=[I_{r,r}|−P^{T}]

or, equivalently,

$${H}_{r , n} = ( \begin{matrix}1 & 0 & 0 & … & 0 & - {p}_{0 , 0} & - {p}_{0 , 1} & {p}_{2 , 0} & … & - {p}_{k - 1 , 0} \\ 0 & 1 & 0 & … & 0 & - {p}_{0 , 1} & - {p}_{1 , 1} & {p}_{2 , 1} & … & - {p}_{k - 1 , 1} \\ 0 & 0 & 1 & … & 0 & - {p}_{0 , 2} & - {p}_{1 , 2} & {p}_{2 , 2} & … & - {p}_{k - 1 , 2} \\ … & … & … & … & … & … & … & … & … & \\ 0 & 0 & 0 & … & 1 & - {p}_{0 , r - 1} & - {p}_{1 , r - 1} & {p}_{2 , r - 1} & … & - {p}_{k - 1 , r - 1}\end{matrix} ) .$$

The parity-check matrix can be used for systematic error detection and error correction. However, parity-check matrices need not be systematic. To generally define the parity-check matrix without assuming a systematic form, the parity-check matrix is an r×n matrix H over F with the property that, for every vector y in Fⁿ, yH=0 if and only if y is a codeword of the code generated by generator G corresponding to parity-check matrix H. Given a generator matrix G of a linear code, it is easy to compute a corresponding parity-check matrix H of the linear code, and vice versa.

Error detection and correction involves computing its syndrome S from an initially received or retrieved message c(r) as follows:

S=(s₀,s₁, . . . ,sᵣ₋₁=c(r)·H^{T}

where H^{T} is the transpose of the parity-check matrix H_{r,n} expressed as:

$${H}^{T} = ( \begin{matrix}1 & 0 & 0 & … & 0 \\ 0 & 1 & 0 & … & 0 \\ 0 & 0 & 1 & … & 0 \\ … & … & … & … & 1 \\ - {p}_{0 , 0} & - {p}_{0 , 1} & - {p}_{0 , 2} & … & - {p}_{0 , r - 1} \\ - {p}_{1 , 0} & - {p}_{1 , 1} & - {p}_{1 , 2} & … & - {p}_{1 , r - 1} \\ - {p}_{2 , 0} & - {p}_{2 , 1} & - {p}_{2 , 2} & … & - {p}_{2 , r - 1} \\ … & … & … & … & … \\ - {p}_{k - 1 , 0} & - {p}_{k - 1 , 1} & - {p}_{k - 1 , 2} & … & - {p}_{k - 1 , r - 1}\end{matrix} ) .$$

Note that, when a binary field is employed, x=−x, so the minus signs above in H^{T} are generally not shown.

The syndrome S is used for error detection and error correction. When the syndrome S is the all-0 vector, no errors are detected in the codeword. When the syndrome includes bits with value “1,” errors are indicated. There are techniques for computing an estimated error vector ê from the syndrome and codeword which, when added by modulo-2 addition to the codeword, generates a best estimate of the original message μ. Details for generating the error vector ê are provided in the above mentioned texts. Note that only up to some maximum number of errors can be detected and fewer than the maximum number of errors that can be detected can be corrected.

### Discuss of the Present Invention

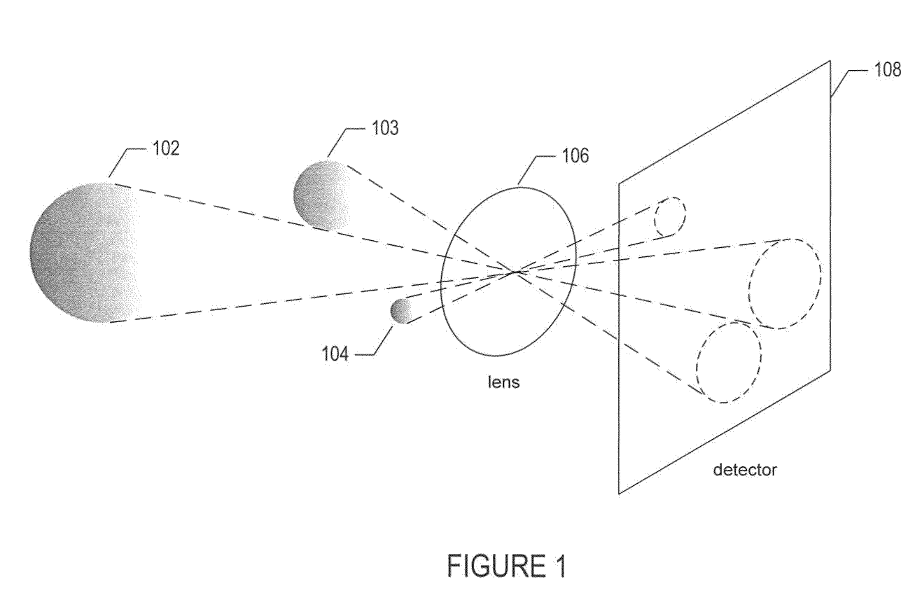

FIG. 1 illustrates image recording by a generalized camera. In FIG. 1, light reflected from three spherical objects 102-104 is focused by one or more camera lenses 106 onto an image detector 108 which records or captures a two-dimensional projection of a portion of the three-dimensional volume on the opposite side of the one or more lenses from the image detector, including the spherical objects 102-104, imaged by the camera. A simple lens system generally creates a two-dimensional projection related to the three-dimensional scene imaged by the camera by inversion symmetry. Modern cameras may employ multiple lenses that provide desirable optical characteristics, including correction of various types of monochromatic and chromatic aberrations, and cameras may employ any of various different types of detectors, including photographic film, CCD integrated-circuit sensors, CMOS integrated-circuit image sensors, and many other types of image capturing subsystems. Recorded images may be stored, directly from electronic detectors or indirectly from photographic film by scanning systems, into electronic memories, where each recorded image is generally represented as a two-dimensional array of pixels, each pixel associated with one or more intensity values corresponding to one or more wavelengths of light. Stored images may be transformed into various alternative different types of digital representations based on various different color systems and image-representation techniques. In this discussion, the phrase “recorded image” refers to an image sensed by an image and stored in an electronic memory or other electronic data-storage device or system.

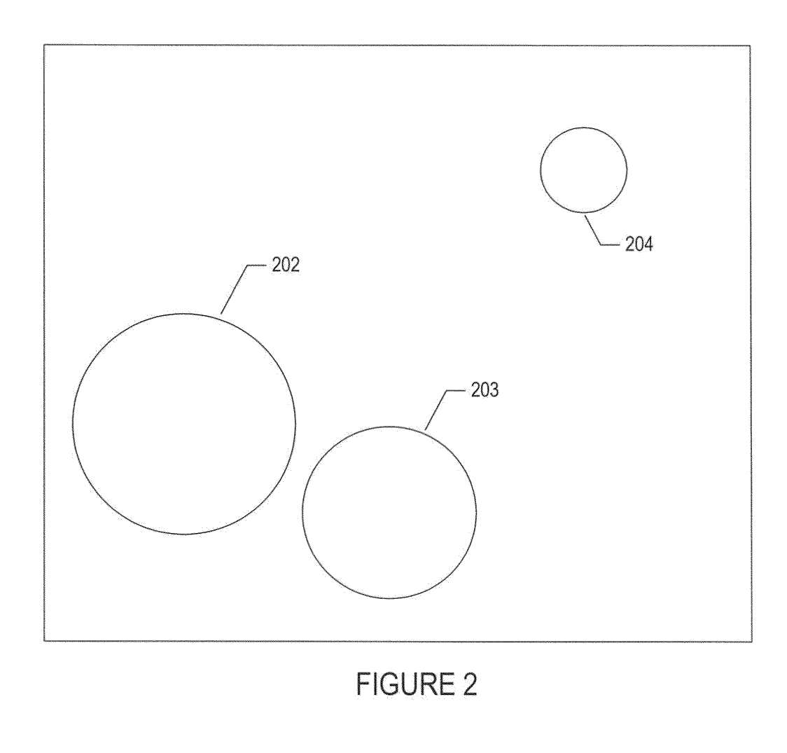

FIG. 2 illustrates the image recorded by the camera, in FIG. 1, as it appears on the surface of an image detector facing towards the lens and imaged scene. The two-dimensional projections 202-204 of the three spherical objects (102-104 in FIG. 1) are arranged within the recorded image in positions related to the positions of the three-dimensional spherical objects as they would appear to an observer looking at the objects from the position of the camera lens. The smallest-appearing spherical projection 204 in the image, positioned highest in the vertical direction, corresponds to a spherical object (104 in FIG. 1) that is lowest, in the vertical direction, among the three spherical objects. However, because the two-dimensional image contains no information regarding the distance of the spherical objects from the lens, it is not possible to determine, from the recorded image, the actual, relative real-world sizes of the spherical objects. For example, spherical object 104 in FIG. 1 is much smaller than spherical objects 102 and 103, but, because spherical object 104 is closer to the camera lens than spherical objects 102 and 103, the size of the two-dimensional projection of spherical object 104, 204 in FIG. 2, appears relatively larger with respect to the two-dimensional projections of spherical objects 102 and 103, 202 and 203 respectively, in FIG. 2, than the actual relative size of the spherical object 104 with respect to spherical objects 102 and 103. Without further information, an observer of a recorded image or an imaging-processing system cannot determine the relative sizes of the three imaged objects and cannot determine the relative distances of the three imaged objects from the camera.

Modern automated image-processing systems employ various techniques to attempt to recover, from a two-dimensional image, including from shading, color variations, and feature identification, at least partial information regarding the distance of three-dimensional objects and surfaces imaged in the two-dimensional image from the image-recording device or system that recorded the two-dimensional images. However, these image-processing techniques provide, at best, imperfect estimates of distances, and the quality of estimated distance information may vary tremendously with the types of imaged scenes and objects, the environmental lighting conditions present when images were recorded, and with other such characteristics and parameters. Stereo photography, in which two separate cameras are employed to image a scene from two different positions and angles, can be used to provide reasonably accurate distance information for near objects. However, stereo photographic systems are complex and expensive, and provide distance information that decreases in accuracy for increasingly distant objects.

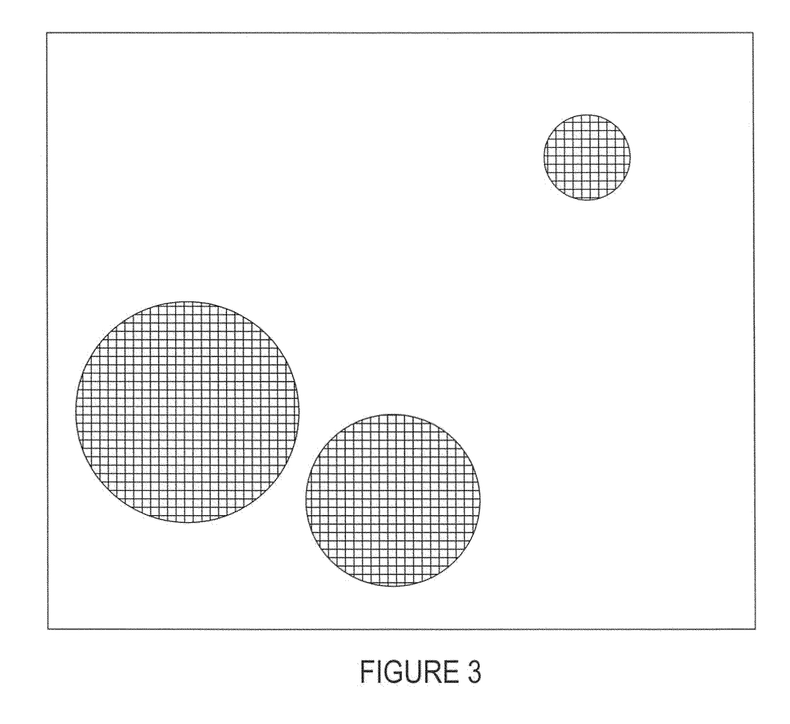

FIG. 3 illustrates a desired level of distance information for two-dimensional images that would facilitate many automated image-processing tasks. FIG. 3 shows the same two-dimensional image representing a projection of the three-dimensional scene including three spherical objects shown in FIG. 1. A grid is shown, in FIG. 3, superimposed over each of the two-dimensional projections of the spherical objects. The area of each element of the grid, in the best possible case, would correspond to relatively small numbers of pixels of the recorded image, but larger-dimensioned grids would nonetheless provide useful information. It would be desirable for distance value to be associated with each cell of the grids, so that the distance between the camera and each of many, relatively uniformly distributed areas of the surfaces of the imaged objects would be known. Such precise distance information would facilitate many different types of automated image-processing techniques as well as facilitate automated extraction of information from two-dimensional images. For example, distance information provided for the imaged objects, as illustrated in FIG. 3, would allow a full, three-dimensional reconstruction of at least those portions of the imaged objects visible in the two-dimensional image. The relative sizes of the objects could be immediately determined, using distance information and known camera geometry and characteristics, and many types of techniques used to enhance image quality could be applied with great precision and effectiveness. A grid of distance information, associated with a two-dimensional image, that indicates distances from the image-recording device to three-dimensional objects and surfaces imaged within grid cells or at grid points, is referred to as a “depth map.”

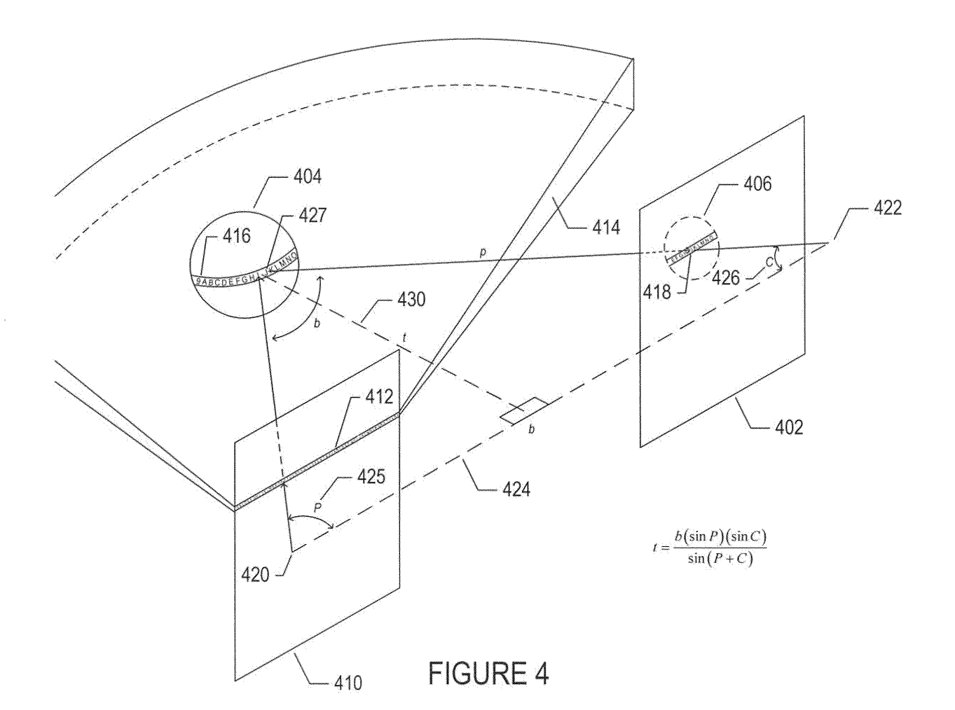

FIG. 4 illustrates the structured illumination technique for associating distance information with a two-dimensional image. In FIG. 4, an image-recording device is represented by a detector plane 402 onto which a three-dimensional object 404 is imaged to produce a two-dimensional projection 406 of the three-dimensional object. The image-recording device may be any of various types of cameras or other devices that through any of various types of optical, chemical, electrical, and/or mechanical subsystems, focuses light from a three-dimensional region onto the two-dimensional image-detection plane 402. A projection device or subsystem 410 is also represented, in FIG. 4, by a plane, in this case a projection plane. However, while the camera records light reflected from, or generated within, a three-dimensional scene, the projection device 410 projects an image recorded on the projection plane out into the three-dimensional region imaged by the camera. For example, in FIG. 4, the plane of the projection device includes a horizontal line 412 of symbols. These symbols are projected outward, in three-dimensional space, as indicated by the wedge-shaped volume 414 through which the line of symbols is projected. Note that, in the imaging system illustrated in FIG. 4, the size of the projected symbols increases with increasing distance from the projector at a rate roughly inversely proportional to the apparent decrease in size, with increasing distance from the camera, of two-dimensional projections of objects recorded on the detector plane 402. Thus, regardless of the distance of a surface from the plane of the projector and camera, the image of a symbol projected by the projector and reflected back to, and recorded by, the camera is relatively constant in size.

In FIG. 4, a portion of the line of symbols projected by the projector 416 fills across the spherical object 404 imaged by the camera. As a result, the camera records an image of the portion of the line of symbols 418 reflected back from the surface of the spherical object 404. When a reference point 420 of the projector and a reference point 422 of the camera are spaced apart by a known distance b 424, and when the positions of the symbols within the line of symbols are known for the projection plane 410 and can be measured within the image plane 402, then the angles P 425 and C 426 can be determined from the geometry of the projector and camera, respectively. The distance from a surface from which the reflected symbol 427 is reflected to the line 424 joining the reference point 420 of the projector to the reference point 422 of the camera, t 430, can be determined, by simple trigonometry and algebra, to be:

$$t = \frac{b ( sin P ) ( sin C )}{sin ( P + C )}$$

as shown in FIG. 4. This triangulation method can therefore be used to determine the distance, or depth-map value, for any surface in the three-dimensional scene that reflects a projected symbol back to the camera that is imaged by the camera. The triangulation method is simplified, in certain structured-illumination devices, by ensuring that the projection plane 410 and image plane 402 are aligned vertically with one another, so that a vertical position of an imaged symbol in the image plane 402 is directly correlated to a vertical position and a particular row of symbols in the projection plane 410. When the projection plane and image plane are thus aligned, the triangulation geometry lies in a plane of a particular line of symbols in the projection plane and corresponding line of potentially-imaged symbols in the image plane. Thus, for any particular imaged symbol, distance information is obtained by computing the angles P 425 and C 426 from the horizontal position of the symbol in the projection plane and a corresponding horizontal position of the symbol in the image plane within a common row of projected and potentially-imaged symbols. Of course, in any actual image-recording setting, only a portion of the projected symbols may be imaged by the imaging device. Thus, the imaging device can generally obtain only incomplete distance information for a recorded image corresponding to those projected symbols that are reflected back from the three-dimensional environment and successfully imaged on the image plane.

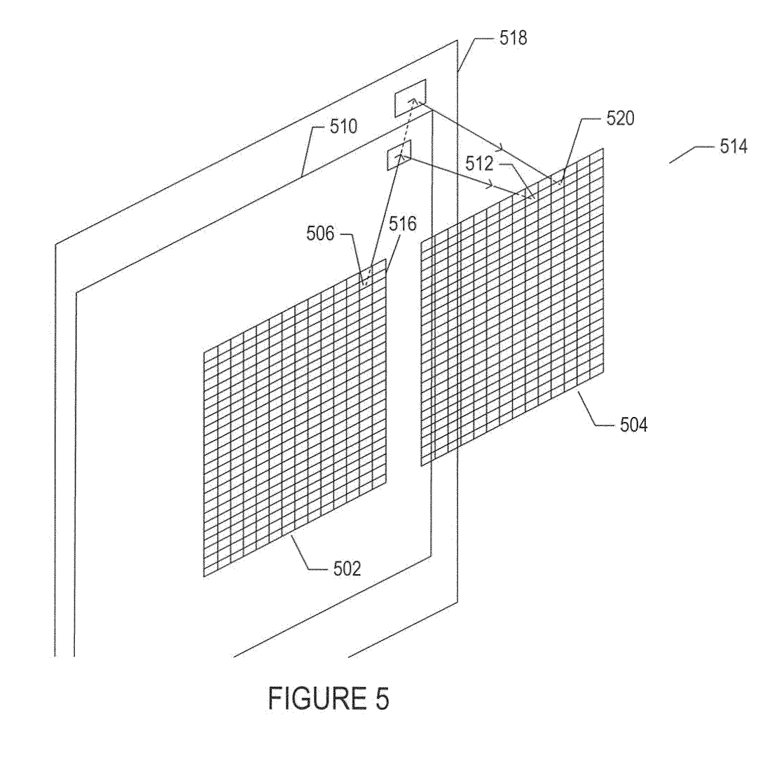

FIG. 5 further illustrates the structured-illumination technique for associating distance information with a two-dimensional image. The structured-illumination approach employs a projector, represented in FIG. 5 by a projection plane 502, which projects a two-dimensional array of symbols out into a three-dimensional environment that is imaged by an image-recording device, represented in FIG. 5 by an image plane 504. As discussed above with reference to FIG. 4, the rows of the two-dimensional array of symbols within the projection plane 502 are aligned with rows of corresponding potentially-imaged symbols, in the image plane. Any symbols projected from a particular row in the projection plane and reflected back from the three-dimensional environment to the image plane fall along a single corresponding row of potentially-imaged symbols within the image plane. In FIG. 5, a particular symbol, indicated by shaded cell 506 within the two-dimensional array of symbols on the projection plane 502, is projected outward by the projector. Were the symbol reflected back to the camera from a first plane 510 in the three-dimensional environment, the symbol would be imaged at a first position 512 in the row or potentially-imaged symbols 514 of the image plane corresponding to the row of symbols 516 in the projection plane that includes the particular symbol. By contrast, were the projected symbol reflected back to the camera from a second, more distant plane 518 in the three-dimensional environment, the symbol would be imaged at a second position 520 within the row of potentially-imaged symbols 514 of the image plane corresponding to the row of symbols 516 in the projection plane that includes the projected symbol 506. Therefore, when the symbols can be uniquely recognized in the image plane and correlated with symbols in the projection plane, then the distance information for a particular position within the image plane can be determined by knowing the horizontal position of the symbol within a row of the projection plane and the horizontal position of the imaged symbol within a corresponding row of potentially-imaged symbols within the image plane. This information, along with information about the projector and camera geometries and the known distance between the projector and camera can be used to determine distance information by the above-provided equation, discussed above with reference to FIG. 4, for surfaces in the three-dimensional environment being imaged that reflect projected symbols back to the image plane. The distance information is included in a depth map associated with, or superimposed over, a recorded image to facilitate image processing.

The above discussion, with reference to FIGS. 1-5, provides an overview and summary of the structured-illumination approach to computing a depth map for a two-dimensional image. The two-dimensional array of symbols can be projected in infrared wavelengths into the three-dimensional environment and imaged at infrared wavelengths that do not interfere with imaging of visible light. Thus, the reflection of projected symbols can be imaged separately from the visible-light image-recording process, providing an overlay of imaged symbols over a recorded image. For example, a visible-light image as well as an infrared-wavelength image can be recorded and aligned with one another as two digital images or as a single digital image with visible-light and infrared-light intensities associated with each pixel. Alternatively, the projected symbols can be separately imaged, at a slightly different point in time, with respect to imaging of the three-dimensional environment to provide an image without symbols reflected back from the three-dimensional environment and an image that includes three-dimensional environment. The above-described triangulation method can then be used, along with symbol recognition methods, to automatically assign distance information to image regions that contain images of recognized, projected symbols by image-processing systems or components of a structured-illumination-based imaging system or device.

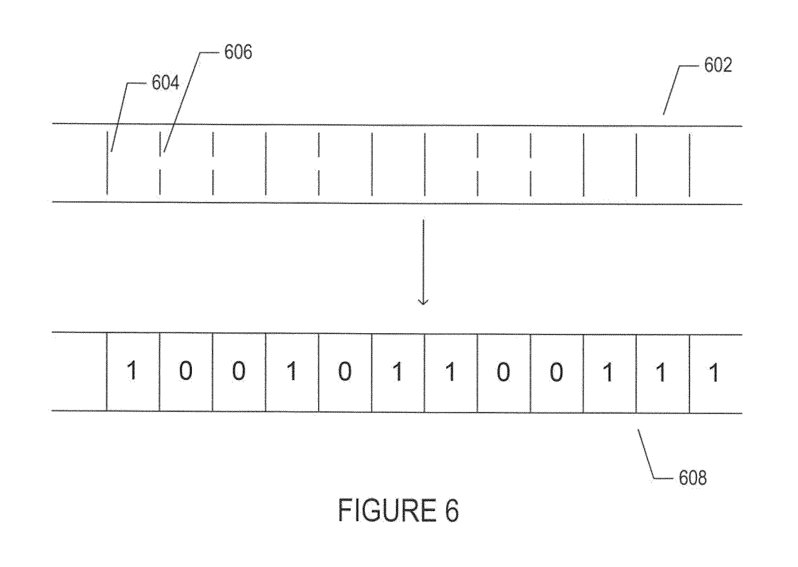

Next, the types of symbols projected by the protector and the contents of the two-dimensional array of symbols projected by the projector are considered. In one structured-illumination technique, a two-dimensional pattern comprising symbols selected from a set of two different types of symbols is projected out into the three-dimensional environment imaged by the camera. FIG. 6 illustrates a portion of one row of symbols projected by such a structured-illumination-based imaging apparatus. The portion of the row of symbols 602 comprises a pattern of two different symbols: (1) a first symbol 604 having the shape of a vertical line; and (2) a second symbol 606 comprising two aligned, vertical line segments spaced apart by a non-illuminated gap. Other sets of symbols may be alternatively used, providing that the symbols are sufficiently different from one another to be readily recognized by image-processing software. The two symbols shown in row 602 of FIG. 6 are interpreted as the two binary digits “1” and “0” by an image-processing system or subsystem. Thus, image-processing methods can be used to process recognizable symbol images in the image-plane into corresponding binary digits. For example, the row of symbols 602 would be processed and stored as the corresponding row of binary digits 608 in FIG. 6, given that the vertical-line symbol 604 is interpreted as Boolean digit “1” and the broken vertical line symbol 606 is interpreted as Boolean digit “0.”

When only two types of symbols are projected, as shown in FIG. 6, a method is needed to ensure that image symbols can be correlated with particular symbols in the two projection plane. One method for facilitating recognition of symbols is to use, as the rows of the two-dimensional projection plane, sequences of symbols that have the property that any contiguous run of k or more symbols occurs only once in the sequence, and therefore any contiguous run of k or more symbols recognized within as row of potentially-imaged symbols of the image plane can be correlated with a unique, identical run of k or more symbols in the corresponding row of symbols in the projection plane. A mathematical sequence referred to as an “M-sequence” has this property, and can be used for structured-illumination purposes.

An M-sequence in which each run of k more symbols occurs uniquely within the M-sequence, referred to as an M-sequence of order k,” can be constructed by a technique based on primitive polynomials over the binary Galois Field (“GF(2)”). A non-zero polynomial over GF(2) can be described as follows:

a+bX¹+cX²+dX³+eX⁴+fX⁵+ . . . +γX^{m}=p(X)
where a, b, c, d, e, fε{0,1} and γ=1;
   X is an indeterminate (variable); and
   the degree of p(X)=m
      A particular polynomial over GF(2), p_{α}(X), is considered primitive when:

the degree of pₐ(X)=m>0

p_{α}(X) is not divisible by any p_{β}(X) of degree t, where 0<t<m; and

the smallest positive integer e for which p_{α}(X) divides X^{e}−1 is e=2^{m}−1

In order to generate an M-sequence with uniquely occurring blocks or consecutive k symbols, referred to as “k-blocks,” a primitive polynomial over GF(2) of degree k is selected and the coefficients of all powers of X in the primitive polynomial are used as a set of feedback taps. For example, for the above-described primitive polynomial degree M, the coefficients {b, c, d, . . . γ} are selected as feedback taps {h₁, hₙ, . . . , hₖ}, where k=M.

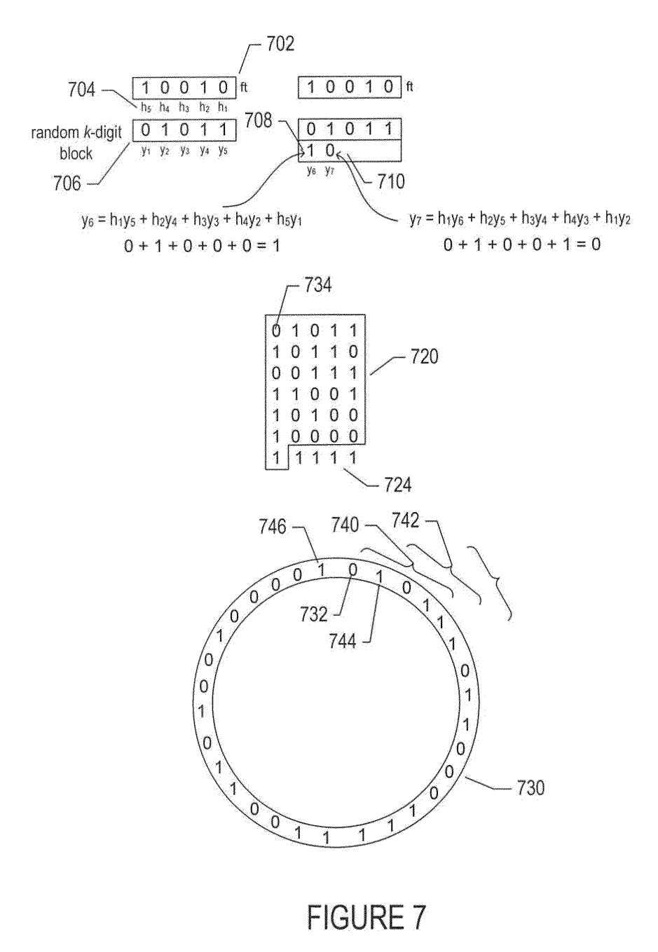

FIG. 7 illustrates a process for generating an M-sequence of order k following selection of a set of k feedback taps from the coefficients of a primitive polynomial over GF(2). In the example shown in FIG. 7, in M-sequence of order k=5 is generated. First, the feedback taps can be placed in a variable array 702, as shown in FIG. 7. The order of the feedback taps is reversed, as indicated by the indices 704 below the variable array, to facilitate illustration of the M-sequence-generation method. Next, the initial k symbols of the sequence can be initialized 706 to any set of k binary-digit values other than the set of all “0” binary-digit values. In the example shown in FIG. 7, the initial five k symbols of the M-sequence, y₁, y₂, . . . , y₅, are chosen to be “01011.” Then, each remaining, successive symbol of the sequence is generated by a difference equation:

yⱼ=h₁yⱼ₋₁+h₂yⱼ₋₂+ . . . hₖyⱼ₋ₖ

For example, the next symbol y₆ 708 in the example M-sequence is generated by the difference equation:

$$\begin{matrix}{y}_{6} = {h}_{1} {y}_{5} + {h}_{2} {y}_{4} + {h}_{3} {y}_{3} + {h}_{4} {y}_{2} + {h}_{3} {y}_{1} \\ = 0.1 + 1.1 + 0.0 + 0.1 + 0.0 \\ = 0 + 1 + 0 + 0 + 0 \\ = 1\end{matrix}$$

as shown in FIG. 7. Similarly, the next symbol y₇ 710 is generated by a difference equation of the same form, as shown in FIG. 7. Continuing with the same process, the sequence of symbols 720 shown in FIG. 7 is generated. The initial 2^{k}-1 symbols of the sequence, in the example shown in FIG. 7, the initial 31 symbols of the sequence, form an M-sequence. These first 31 symbols are enclosed within an almost rectangular box 720 with a few additional symbols 724 generated by additional successive application of the difference equation shown outside of the box. In FIG. 7, the 31 symbols of the M-sequence are alternatively arranged in as circular form 730. The “0” symbol 732 corresponds to symbol “0” 734 in the rectangularly displayed sequence 720. Any starting point can be used, and an M-sequence is generated by proceeding from an arbitrary starting point in either direction.

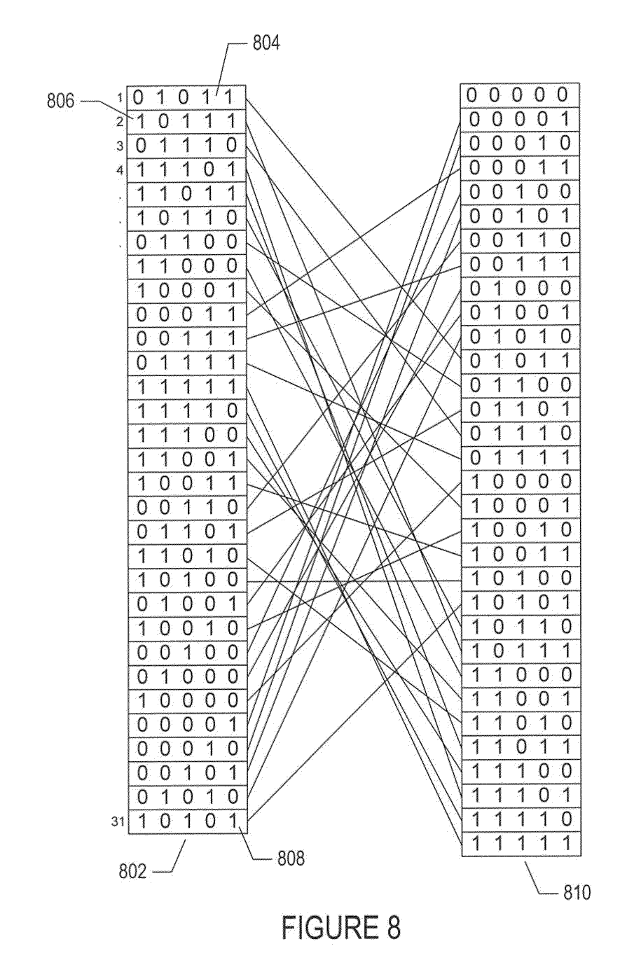

FIG. 8 illustrates the uniqueness property of the M-sequence with respect to all k-blocks extractable from the M-sequence. Starting with the “0” symbol 732 in the circular arrangement of the M-sequence 730 shown in FIG. 7, each possible k-block can be extracted and placed into a column of extracted k-blocks 802 in FIG. 8. For example, the first five symbols “01011” 740 in FIG. 7 are extracted as a first k-block and placed into the first k-block entry 804 of the column of possible k-blocks 802. The next possible k-block 742 begins by starting one symbol rightward from the starting point of the first k-block with the “1” symbol 744. The second k-block is thus “10111,” which is placed into the second entry 806 of the column 802 of the k-block shown in FIG. 8. This process can be continued to generate 31 possible k-blocks, with the final k-block 808 starting from the “1” symbol 746 in the circularly arranged M-sequence 730 shown in FIG. 7.

Next, all possible five-binary-digit numbers are listed in ascending order in the entries of a second column 810 in FIG. 8. Lines are drawn, in FIG. 8, between entries in the first column 802 and entries in the second column 810 containing identical five-binary-digit values. As can be seen by closely examining FIG. 8, each and every non-zero five-binary-digit number occurs in one and only one entry of the possible k-blocks in column 802. Thus, FIGS. 7 and 8 demonstrate that the M-sequence of k-blocks generated by the method discussed above with reference to FIG. 7 has the property that each contiguous run of k=5 digits occurs only once in the M-sequence. Thus, any consecutive subsequence of five or more binary digits occurs only once in the M-sequence, in the k=5 example shown in FIG. 7. As a result, a unique position within the M-sequence can be determined for any run of five or more binary digits extracted from the M-sequence. If a sufficiently large M-sequence is chosen as the symbols within a particular row of symbols of the projection plane, discussed above with reference to FIGS. 4 and 5, then when k or more consecutive symbols can be recognized in the corresponding row of potentially-imaged symbols in the image plane, the position of those k or more recognized consecutive symbols can be uniquely identified within the M-sequence contained in the particular row of the projection plane. Because the vertical position of symbol sequences imaged in the image plane align with the vertical position of a corresponding row of the projection plane, the same M-sequence of binary symbols can be used for each row of the two-dimensional array of symbols within the projection plane.

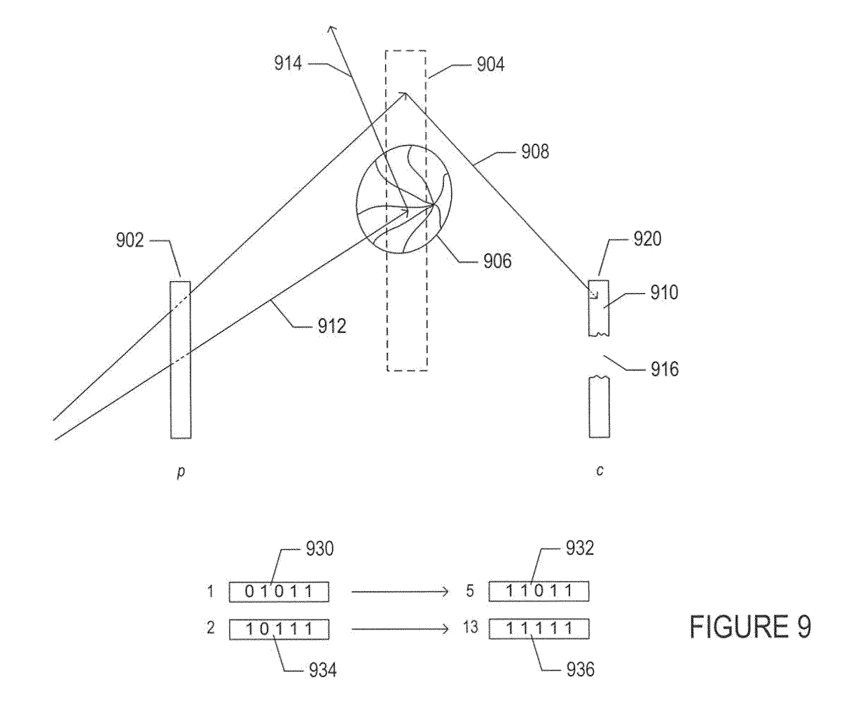

Unfortunately, recognition of individual symbols in the image plane is generally error prone. For any of many different reasons, a projected vertical-bar symbol may end up being imaged as a two-segment, vertical-bar symbol, and a projected two-segment, vertical-bar symbol may end up being imaged as a vertical-bar symbol. FIG. 9 illustrates incorrect imaging of a projected symbol. In FIG. 9, a vertical-bar symbol 902 in the projection plane is projected onto a surface 904 in the three-dimensional environment being imaged by a camera that includes a cone-like or hump-like feature 906. While light rays reflecting from the flat portion of the surface, such as light ray 908, are faithfully imaged on the image plane 910, projected light rays, such as projected light ray 912, that impinge, on the cone-like or hump-like feature 906 may be scattered 914, as a result of which the central portion of the projected vertical-bar symbol 902 fails to be imaged 916. An image-processing system may thus interpret the imperfectly imaged vertical-bar symbol 920 not as the vertical-bar symbol 902 originally projected, but instead as a two-segment, vertical-bar symbol due to scattering of light rays by the cone-like hump 906. This results in a bit inversion or bit flipping of the imaged symbol with respect to their corresponding projected symbol by an image-processing subsystem or subcomponent of a structured-illumination-based image-recording device or system. FIG. 9 shows two single-bit inversions in k-blocks of the M-sequence discussed above with reference to FIGS. 7 and 8. Were the five-symbol sequence 930 projected, but as a result of incorrect symbol recognition, the first bit of the five-symbol sequence 932 was inverted by the image-recognition system that processes the infrared image of the projected symbols, then, referring back to column 802 in FIG. 8, the position of the imaged subsequence of five symbols, or imaged k-block, within the projection-plane M-sequence would be incorrectly inferred to start with the fifth symbol of the M-sequence rather than the first symbol of the M-sequence. Similarly, were the five-symbol subsequence 934 projected, but due to bit inversion of the second symbol of the subsequence, the projected five-symbol subsequence 934 was recognized as the five-symbol subsequence 936 by the image-processing subcomponent, then the position of the imaged five-symbol subsequence within the M-sequence would be inferred to begin with the 13^{th} symbol of the M-sequence rather than correctly inferred to begin with the second symbol of the M-sequence. Therefore, even a single bit inversion may lead to quite incorrect assignments of imaged symbol subsequences to positions within corresponding rows of the projection plane, and thus lead to very incorrect derived depth-map values for the symbol sequences.

Certain examples of the current invention are directed to creating and using M-like sequences, referred below to as “M*-sequence” as rows, or portions of rows, of projection-plane symbols in a structured-illumination-based imaging device or system. Each block of n consecutive symbols in an M*-sequence occurs uniquely within the M*-sequence, just like each k-block occurs uniquely in an M-sequence. In addition, the Hamming distance between any two n-blocks extracted from an M*-sequence is greater than or equal to a Hamming distance d characteristic of the particular M*-sequence. The distance between two n-blocks is, as discussed in the above-provided discussion of error-control coding, the number of positions within the two n-blocks at which the symbol at that position in the first n-block differs from the corresponding symbol at that position in the second n-block. Thus, an M*-sequence is similar to an M-sequence, but associated with the additional characteristic that all of the n-blocks within the M*-sequence are separated from one another by distances greater than or equal to a minimum Hamming distance d. M*-sequence is characterized as having an (n,d) reliability, or as being (n,d) reliable, when each n-block that can be extracted from the M*-sequence uniquely occurs in the M*-sequence and when all such n-blocks are separated from one another by Hamming distances equal to or greater than d.

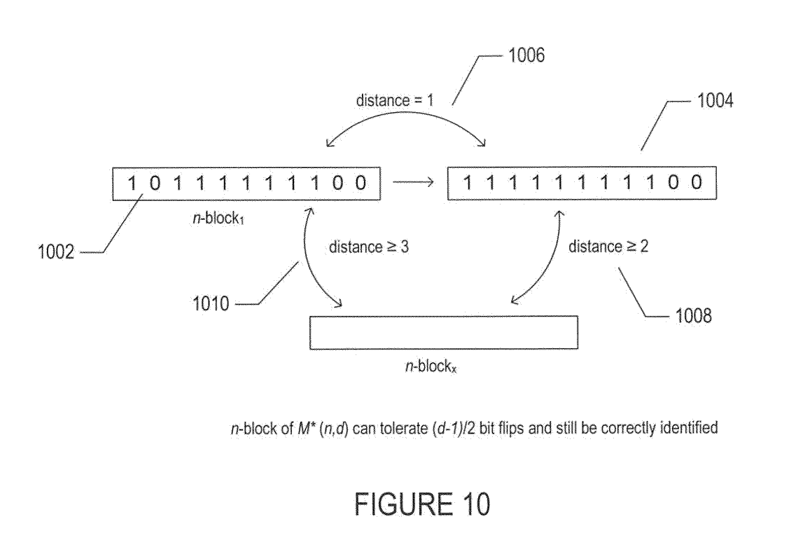

FIG. 10 illustrates the advantage of M*-sequences over traditional M-sequences, according to certain examples of the present invention, when used in rows of symbols in projection planes of structured-illumination-based imaging devices and systems. In FIG. 10, the value of an n-block 1002 from an (11,3) reliable M*-sequence is shown as the sequence 1002. The n-block following a single-bit flip, or single-bit inversion, is shown in sequence 1004. The second symbol of the original sequence 1002 is inverted from “0” to “1.” Because the original n-block and corrupted n-block differ in value only at a single symbol position, the Hamming distance between the original n-block 1002 and the corrupted n-block 1004 is 1 (1006 in FIG. 10). Because the M*-sequence features n-blocks that are at a minimum Hamming distance of 3 from one another, the corrupted n-block 1004 does not occur in the M*-sequence from which the original n-block 1002 was extracted. Therefore, the corrupted sequence 1004 can be immediately identified as a corrupted n-block by an image processing system that can access a table of possible n-blocks from the M*-sequence. Moreover, the Hamming distance between the original n-block and any other n-block of the M*-sequence is greater than or equal to 3 1010, while the minimum Hamming distance between the corrupted n-block and any other n-block sequence in the M*-sequence is greater than or equal to 2 (1008 in FIG. 10). Therefore, the original n-block can be determined from the corrupted n-block 1004 by identifying the n-block within the table of M*-sequence n-blocks that is closest, in Hamming distance, to the corrupted n-block 1004. The n-block in the M*-sequence closest to the corrupted n-block 1004 can be unambiguously determined to be the original n-block sequence 1002, given that only a single bit inversion occurred to produce the corrupted n-block. In general, the correct n-block corresponding to a corrupted n-block, when the correct n-block is selected from an (n,d) reliable M*-sequence, can be unambiguously determined when (d−1)/2 or fewer bit flips or bit inversions have occurred during the corruption process.

One approach to generating symbol sequences for projection planes, according to certain examples of the present invention, is to create and use an (n,d) reliable M*-sequence where n is the minimal that provides (n,d) reliability and where the probability of more than (d−1)/2 bit flips in a consecutive sequence of n symbols is below a threshold value past which the rate of errors would be unacceptable. As n increases, the probability of recognizing it given projected n-block in a recorded image and the granularity of a depth map that can be obtained for the recorded image both decrease. Thus n should be chosen to be as small as possible in order to provide a sufficient Hamming distance d to guarantee an acceptably low rate of n-block misinterpretation.

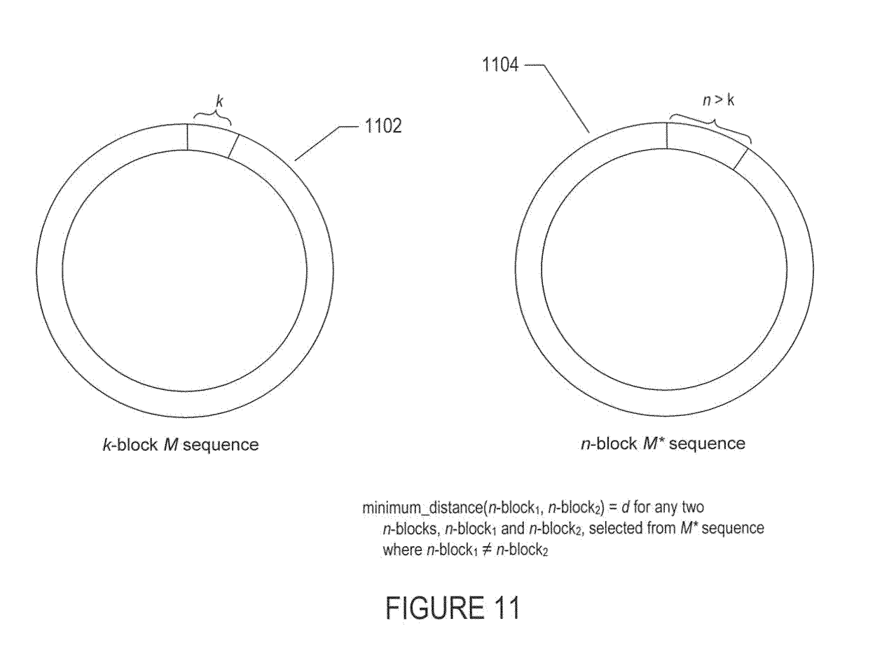

FIGS. 11-13 illustrate one approach to generating an M*-sequence with a desired n-block length n and desired minimum Hamming distance d according to one example of the present invention. In this approach, as shown in FIG. 11, a traditional M-sequence of order k 1102 may be alternatively used as an n-block M*-sequence 1104, with n>k, when the M-sequence of order k 1102 is identified to certain characteristics. The M-sequence of order k 1102 has the characteristic that any block of k or more consecutive symbols within the sequence occurs uniquely and that every possible sequence of k symbols, other than the all-0 sequence, occurs once within the M-sequence of order k. For certain M-sequences, there is an integer n, where n>k, for which any pair of n-block sequences extracted from the M*-sequence from different starting positions within the M*-sequence have a minimum Hamming distance of d, and, since the M*-sequence is an M-sequence of order k<n, any consecutive sequence of symbols of length n or greater occurs once within the M*-sequence.

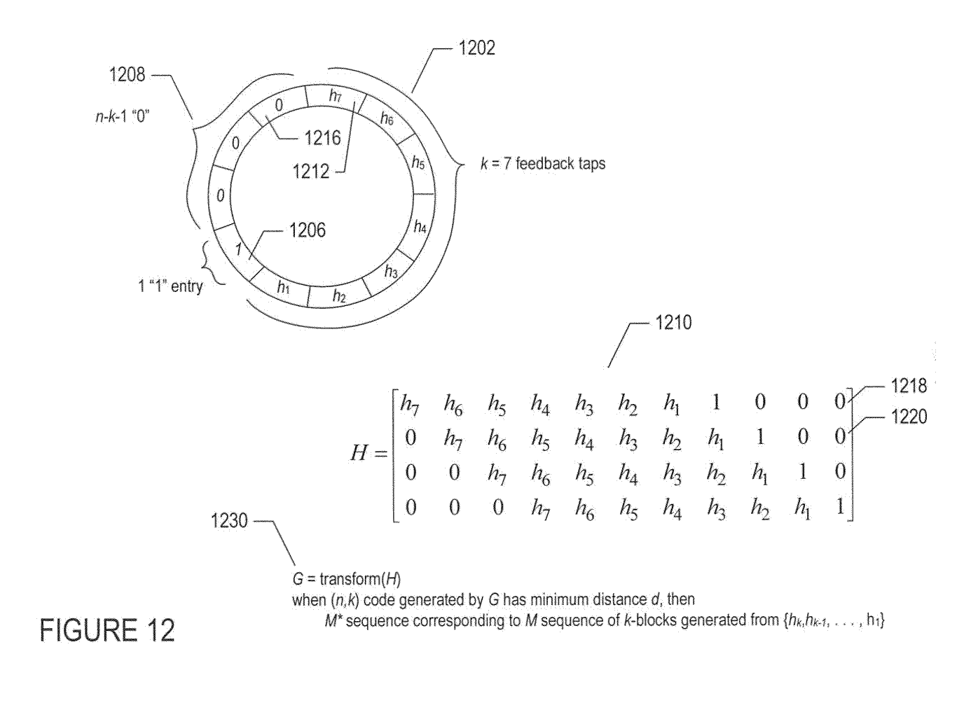

Given any particular M-sequence of order k, it is possible to determine whether the particular M-sequence of order k can be employed as an n-block M*-sequence with reliability (n,d) by a method illustrated in FIG. 12. First, a circular sequence of n symbols 1202 is constructed, as illustrated in FIG. 12, from the k feedback taps used to generate the M-sequence of order k, {hₖ, hₖ₋₁, . . . h₁}, to which a single “1” symbol is appended 1206, following which n−k−1 “0” entries 1208 are appended to form the circular n sequence 1202. In FIG. 12, an example of a circular n-symbol sequence is generated for an M-sequence of order k where k is equal to 7. Next, a non-systematic parity-check matrix H 1210 is generated from the circular n sequence by extracting successive rows of n symbols from the circular n-symbol sequence 1202, with the first row starting at the position of the highest-order feedback tap, in the example shown in FIG. 12, h₇ 1212. In other words, the circular n sequence is broken between the highest-order feedback tap 1212 and the final “0” entry 1216 to create a linear sequence of n symbols, which is then used to form the first row 1218 of the parity-check matrix H. The starting point for extracting the next row of the parity-check matrix H from the circular sequence 1202 is then advanced in a counter-clockwise direction by one symbol and the next n-element row 1220 of the parity-cheek matrix H is created by breaking the circular sequence 1202 between the final appended “0” 1216 and the preceding “0” to create the next linear sequence 1220 added as the second row to the parity-check matrix H. This process continues in order to produce n−k parity-check-matrix rows. In the example shown in FIG. 12, n=11 and k=7, so the parity-check matrix is an (n−k)×n matrix, or a 4×11 matrix.

As discussed in the above-provided section on error-control-coding concepts, a parity-check matrix H can be transformed into a corresponding generator matrix G 1230 by the inverse of the transformation of a generator matrix G to a corresponding parity-check matrix H. When the linear-block code (n,k) generated by the generator matrix G corresponding, to parity-check matrix H has a minimum Hamming distance d, then the M*-sequence that includes n-blocks corresponding to code words of the (n,k) linear block code generated by the G matrix is (n,d) reliable or, in other words, the n-blocks within the M*-sequence corresponding to the M-sequence of order k generated by the feedback taps used to create the circular n-symbol sequence 1202 that is, in turn, used to generate the parity-check matrix H 1210 have the property that any two n-blocks extracted from the M*-sequence are separated by a minimum distance of d. Well-known error-control-coding techniques can be used to determine the minimum Hamming distance between code words of a linear block code generated by a particular generator matrix G.

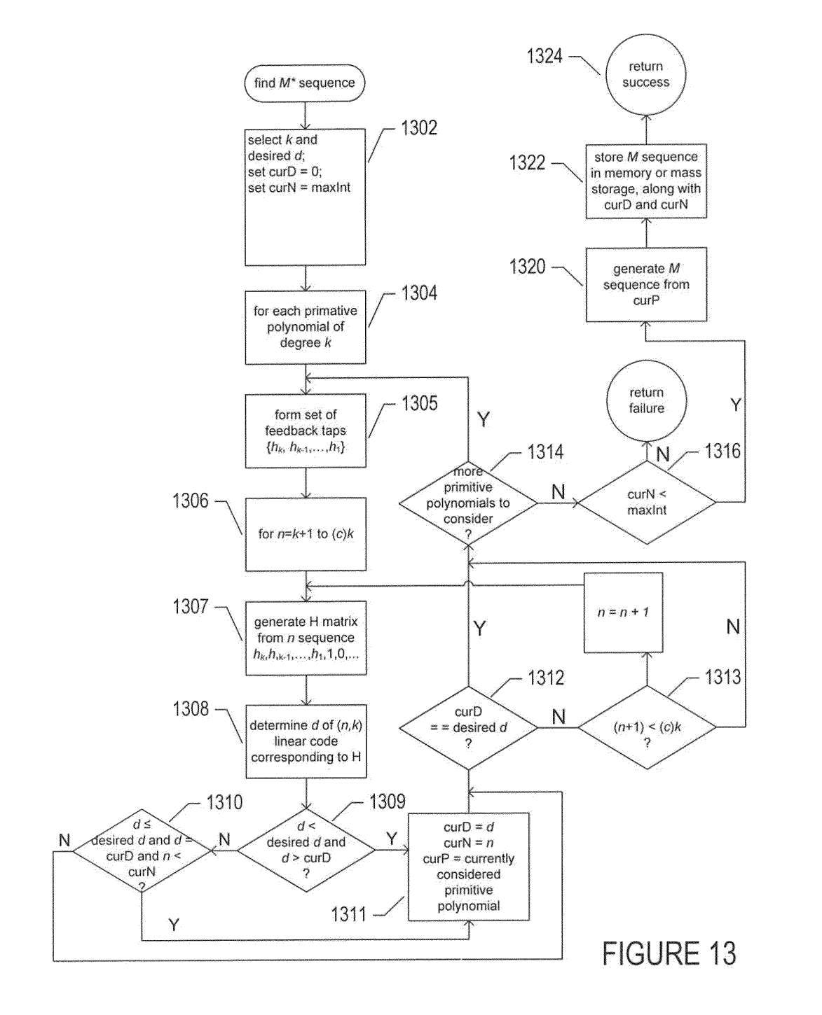

FIG. 13 provides a control-flow diagram that illustrates a method for generating a desired M*-sequence according to one example of the present invention. In block 1302, a desired k-block length k and a desired minimum Hamming distance d are selected or received as input. Local variables curD and curN are additionally set to 0 and maxInt, respectively, where maxInt is a very large integer. The for-loop of blocks 1304-1314 considers each possible primitive polynomial of degree k. Note that tables of primitive polynomials for each degree over a range of possible degrees have been compiled, so that each primitive polynomial considered in the for-loop of blocks 1304-1314 can be selected as a next entry in a table of primitive polynomials of a particular degree k. In block 1305, a set of feedback taps is created from the coefficients of the currently considered primitive polynomial, as discussed above with reference to FIG. 9. Then, in the for-loop of blocks 1306-1313, possible values of n, the n-block length for an M*-sequence corresponding to the k-block sequence that can be generated using the feedback taps obtained in block 1305, are considered up to a largest n obtained by multiplying k by a cutoff ratio c. As discussed above, it is desirable to minimize the additional symbols in n blocks, n−k, needed to provide the minimum-Hamming-distance separation between n blocks in the M*-sequence. In block 1307, the parity-check matrix H is generated from the circular sequence of n symbols generated from the feedback taps selected in block 1305 by the method illustrated in FIG. 12. In block 1308, the minimum Hamming distance d of the (n,k) linear block code corresponding to the parity-check matrix H is determined by well-known error-control-coding techniques. When the determined minimum Hamming distance d is less than the desired d, selected or received in block 1302, and the determined d is greater than the value stored in the local variable curD, as determined in block 1309, then the local variables curD, curN, and curP, are set to the determined value d, the currently considered n-block length n, and the currently considered primitive polynomial, respectively, in block 1311. Alternatively, when the minimum Hamming distance d determined in block 1308 is less than or equal to the desired d, the minimum Hamming distance determined in block 1308 is equal to the value stored in the variable curd, and the currently considered n-block length n is less than the value stored in the local variable curN, as determined in block 1310, then the values of local variables curD, curN, and curP are set to d, n, and the currently considered primitive polynomial in block 1311, as discussed above. In other words, blocks 1309 and 1310 ensure that whenever a newly considered M*-sequence has a minimum distance closer to the desired minimum distance or a minimum distance no worse than the best minimum distance so far obtained and a block length n less than the least block length so far observed, then the currently considered M*-sequence is referenced as the most suitable M*-sequence so far obtained in the search carried out by the nested for-loops of blocks 1304-1314. When the current best minimum Hamming distance is equal to the desired minimum distance, as determined in block 1312, then the inner for-loop of the nested for-loops is exited and, in block 1314, the method determines whether or not there are more primitive polynomials to consider in the outer for-loop. If so, then control flows back to block 1306. Otherwise, control flows to block 1316, discussed below. When the current best minimum Hamming distance is less than the desired distance, as determined in block 1312, and n is less than ck, indicating that there are more values of n to consider, as determined in block 1313, then the inner for-loop of blocks 1306-1313 is continued with consideration of a next value of n. Otherwise, the innermost for-loop terminates and control flows to block 1314, discussed above. When there are no more primitive polynomials to consider, as determined in block 1314, then, in block 1316, the method determines whether or not the value stored in curN is less than maxInt, indicating that a M*-sequence was found. If not, then failure is returned in block 1318. If so, then the M-sequence corresponding to the primitive polynomial stored in local variable curP is generated, in block 1320, and the M-sequence is stored in memory or mass storage for subsequent use in structured-illumination applications, along with the values currently stored in local variables curD and curN, in block 1372. Finally, success is returned in block 1324.

It should be noted that an M-sequence can be seen as an M*-sequence with reliability (n,d) for a limited range of n and d where this range depends on the M-sequence. In other words, searching for an M*-sequence with a specified reliability of (n,d) is non-trivial. Furthermore, in practical applications of structured illumination, the matching of imaged n-blocks to n-blocks of an M*-sequence needs to be carried out by hardware or hardware-and-software implemented automated processing components in order to provide levels of time efficiency and accuracy needed for practical image-recording and image processing.

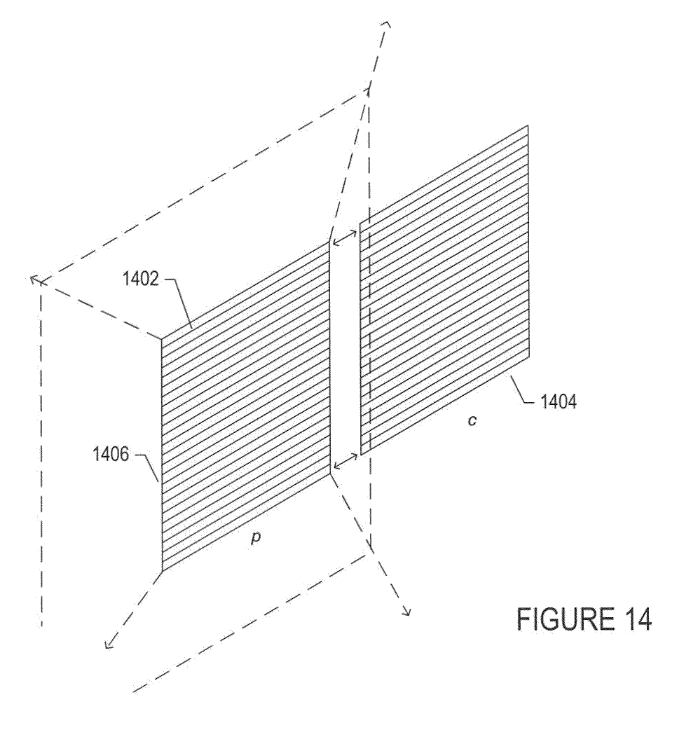

FIG. 14 illustrates one imaging-system example of the present invention. Certain examples of the present invention are directed to an image-recording device or system that employs structured illumination in order to provide depth-map values for regions of the recorded image. In these examples of the present invention, each row of the two-dimensional array of symbols projected by a projector into a three-dimensional environment is imaged by a camera, such as row 1402, includes one or more M*-sequences. In certain examples of the present invention, each row of the two-dimensional array projected symbols contains a single binary M*-sequence, so that a distances value can be calculated and associated with each region of the recorded image in which n-consecutive symbols of a corresponding row of potentially-imaged symbols in the image plane can be recognized. Because of the fixed geometry and relationship between the projector and camera in a structured-illumination-based apparatus, it may be the case that two or more copies of an M*-sequence can be concatenated to produce a row of the two-dimensional array of projected symbols, because the position in the recorded image of any n-block reflected back from the 3D environment can be used to unambiguously determine both which copy of the M*-sequence included the projected n-block as well as the position of the projected n-block within the determined copy of the M*-sequence. In certain examples of the present invention, the same M*-sequence or sequence obtained by concatenating two or more M*-sequences can be used for each row of the two-dimensional array of projected symbols, since the vertical position of recorded images of projected symbols in the image plane can be used to unambiguously determine the row of the two-dimensional array of projected symbols from which the symbols were projected, as discussed above. In alternative examples of the present invention, different M*-sequences can be used for different rows of the two-dimensional array of projected symbols, or as single very long M*-sequence may be used to fill all or multiple rows of the two-dimensional array of projected symbols. As discussed above, the structured-illumination-based image-recording apparatus is abstractly shown in FIG. 14, and in previous figures, as an image plane 1404 of a detector within the image-recording apparatus and a projection plane 1406 within a symbol-projecting apparatus that is row aligned with the image plane 1404. Many different types of optical, electromechanical, chemical, or hybrid apparatuses can be used to record images on a detector plane and to project a two-dimensional array of symbols from a projection plane into a three-dimensional environment that is being imaged by a structured-illumination-based device or apparatus that includes an image-recording subcomponent and a projection component.

The following two M*-sequences corresponding to M-sequences of order k=7 have reliabilities (11,3) and (16,5), respectively:

y_{7,11,3}=(y₁,y₂, . . . y₁₂₇)=100000001010110111111100110110101010001001001100111100011101110101 11101001011001010011100100011000101110000100001101000001111101

y_{7,16,5}=(y₁,y₂, . . . y₁₂₇)=10000001110101000101110001111011101101011111110100110000110100001 01001011011001010101100010000010011111001110010010001100110111

These are two examples of the many different possible M*-sequences that can be employed in structured-illumination applications.

Decoding or matching of n-blocks recognized in a recorded image to n blocks of a corresponding projected M*-sequence can be a automatically carried out by image-processing systems, in many cases, by simply finding the closest matching n-block within the M*-sequence, as discussed above with reference to FIG. 10. For automated image processing, this method can be facilitated by preparing a table indexed by all possible n-block values with entries containing the closest, matching n-block from the M*-sequence. For larger values of n, a syndrome decoder for the linear block code with parity-check matrix H can be used to correct any errors in the imaged and processed n-block, and the error-corrected n-block can then be used to locate the corresponding position within the M*-sequence, either directly or by a table-lookup procedure. Note that only the first k bits of a corrected n-block need to be used to determined the position of the n-block within the M*-sequence.

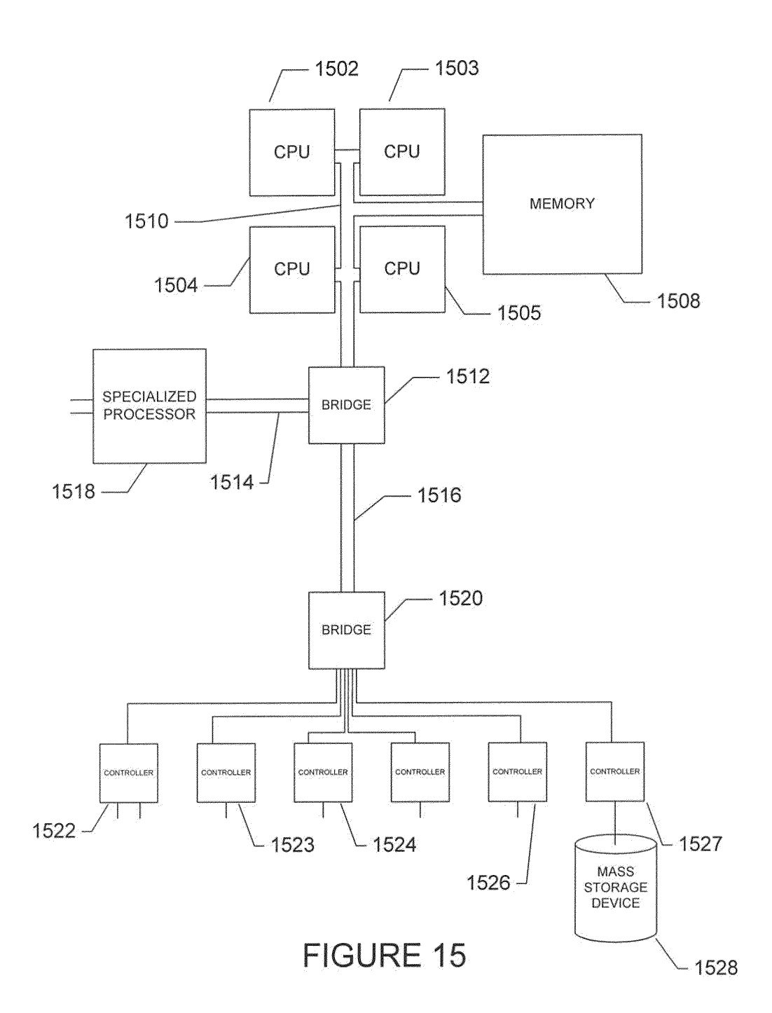

FIG. 15 illustrates a generalized computer architecture for a computer system that, when controlled by a program to generate M*-sequences or to decode n-blocks of M*-sequences recognized in recorded images, and that represents one example of the present invention. The computer system contains one or multiple central processing units (“CPUs”) 1502-1505, one or more electronic memories 1508 interconnected with the CPUs by a CPU/memory-subsystem bus 1510 or multiple busses, a first bridge 1512 that interconnects is the CPU/memory-subsystem bus 1510 with additional busses 1514 and 1516, or other types of high-speed interconnection media, including multiple, high-speed serial interconnects. These busses or serial interconnections, in turn, connect the CPUs and memory with specialized processors, such as a graphics processor 1518, and with one or more additional bridges 1520, which are interconnected with high-speed serial links or with multiple controllers 1522-1577, such as controller 1527, that provide access to various different types of mass-storage devices 1528, electronic displays, input devices, and other such components, subcomponents, and computational resources. Examples of the present invention may also be implemented on distributed computer systems and can also be implemented partially in hardware logic circuitry.

Although the present invention has been described in terms particular examples, it is not intended that the invention be limited to these examples. Modifications will be apparent to those skilled in the art. For example, as discussed above, M*-sequences can be employed in the two-dimensional array of projected symbols in any of many different types of structured-illumination-based image-recording devices and systems. As discussed above, certain examples of the present invention employ a single M*-sequence for each row or the two-dimensional array of symbols projected into a three-dimensional environment by a projecting apparatus within a structured-illumination-based imaging device or system. It is convenient for automated image processing to use binary M*-sequences containing only two different types of symbols. However, M*-sequences based on larger symbol sets and number systems with bases greater than 2 can also be employed. As discussed above, in certain cases, two or more copies of an M*-sequence can be concatenated to form rows of a two-dimensional projection plane. In addition, two or more M*-sequences can be used fear different rows of a two-dimensional symbol array. Methods for constructing M*-sequences and for decoding n-blocks recognized in recorded images can be implemented in hardware or a combination of hardware and software by varying any of many different implementation parameters, including data structures, modular organization, control structures, variables, programming language, underlying operating system, and many other such implementation parameters. In the above discussion, the projection subcomponent and imaging subcomponent of a structured-illumination-based image-recording device or system are shown side-by-side, but in alternative examples of the present invention, the projection subcomponent and imaging subcomponent may be vertically displaced from one another, displaced from one another in other directions, or the displacement may be varied mechanically or electromechanically, with the displacement fixed and recorded for each imaging operation.

The foregoing description, for purposes of explanation, used specific nomenclature to provide a thorough understanding of the invention. However, it will be apparent to one skilled in the art that the specific details are not required in order to practice the invention. The foregoing descriptions of specific examples of the present invention are presented for purpose of illustration and description. They are not intended to be exhaustive or to limit the invention to the precise forms disclosed. Many modifications and variations are possible in view of the above teachings. The examples are shown and described in order to best explain the principles of the invention and its practical applications, to thereby enable others skilled in the art to best utilize the invention and various examples with various modifications as are suited to the particular use contemplated. It is intended that the scope of the invention be defined by the following claims and their equivalents:

1. An image-recording device comprising:
an imaging component that records an image of an environment;
a projection component that projects, into the environment, an (n,d) reliable M*-sequence of symbols; and
a distance component that
identifies j consecutive symbols reflected back to the imaging component from a surface in the environment, where j≧n
detects and corrects a misidentified symbol within the j consecutive symbols based on the minimum Hamming distance d of the (n,d) reliable M*-sequence,
determines a first position of the j consecutive symbols with respect to the image,
determines a second position of the j consecutive symbols in the M*-sequence of symbols, and
determines, from the first and second position, a distance t from the surface to the imaging component.

2. The image-recording device of claim 1
wherein the projection component projects the M*-sequence of symbols in a non-visible-light wavelength;
wherein the image-recording device records the image as a single two-dimensional array of pixels, each pixel associated with one or more visible-light intensities and a non-visible-light-wavelength intensity; and
wherein the distance component determines the first position by identifying the subsequence of j consecutive symbols in the image by using the non-visible-light-wavelength intensities associated with pixels of the image.

3. The image-recording device of claim
wherein the projection component projects the M*-sequence of symbols in a non-visible-light wavelength;
wherein the image-recording device records the image as two two-dimensional arrays of pixels, each pixel in the first two-dimensional array of pixels associated with one or more visible-light intensities and each pixel in the second two-dimensional array of pixels associated a non-visible-light-wavelength intensity; and
wherein the distance component determines a position of the subsequence of j consecutive symbols in the second image and determines the first position by identifying a position in the first image corresponding to the position of the subsequence of j consecutive symbols in the second image.

4. The image recording device of claim 1
wherein projection component projects the M*-sequence of symbols for imaging by the imaging component to produce a reflected-symbol image; and
wherein the image-recording device records the image of the environment when the projection component is not projecting the M*-sequence of symbols; and
wherein the distance component determines a position of the subsequence of j consecutive symbols in the reflected-symbol image and determines the first position by identifying a position in the image of the environment corresponding to the position of the subsequence of j consecutive symbols in the second image.

5. The image-recording device of claim 1 wherein the projection component projects a two-dimensional array of symbols into the environment.

6. The image-recording device of claim 5 wherein the two-dimensional array of symbols projected by the projection component into the environment is aligned with the two-dimensional array of pixels produced in an imaging operation by the imaging component.

7. The image-recording device of claim 5 wherein each row of the two-dimensional array of symbols comprises one or more M*-sequences of symbols.

8. The image-recording device of claim 5 wherein each column of the two-dimensional array of symbols comprises one or more M*-sequences of symbols.

9. The image-recording device of claim 5 wherein the two-dimensional array of symbols comprises an M*-sequence of symbols, successive subsequences of which are selected or each row of the two-dimensional array of symbols.

10. The image-recording device of claim 5 wherein the two-dimensional array of symbols comprises an M*-sequence of symbols, successive subsequences of which are selected for each column of the two-dimensional array of symbols.

11. The mage-recording device of claim 1 wherein the distance component determines, from the first and second position, a distance t from the surface to the imaging component by:
determining, from a known geometry of, and relative positions of components within, the image-recording device, a base distance b along a base line from a first reference point associated with the projection component to a second reference point associated with the imaging component;
determining, from a known geometry of and relative positions of components within, the image-recording device and from the first and second position, a projection angle P between a line of symbol projection from the first reference point to the surface in the environment and the base line and a camera angle C between a line of symbol reflection from the surface in the environment to second reference point and the base line; and
determining a distance t from the surface to the image-recording device as
$$t = \frac{b ( sin P ) ( sin C )}{sin ( P + C )} .$$

12. The image-recording device of claim 1 wherein the distance component detects and corrects a misidentified symbol within the j consecutive symbols based on the minimum distance d of the (n,d) reliable M*-sequence by:
determining, from a known geometry of, and relative positions of components within, the image-recording device, an M*-sequence projected by the projection component that includes symbols reflected back to the imaging component as the j consecutive symbols;
employing a syndrome decoder for a linear block code comprising codewords of length n corresponding to the M*-sequence to determine a most likely subsequence of n consecutive symbols within the M*-sequence corresponding to n consecutive symbols within the j consecutive symbols.

13. The image-recording device of claim 1 wherein the distance component detects and corrects a misidentified symbol within the j consecutive symbols based on the minimum distance d of the (n,d) reliable M*-sequence by:
determining from a known geometry of, and relative positions of components within, the image-recording device, an M*-sequence projected by the projection component that includes symbols reflected back to the imaging component as the j consecutive symbols; and
determining, as a most likely subsequence of n consecutive symbols within the M*-sequence, a subsequence of n consecutive symbols within the M*-sequence closest in Hamming distance to a corresponding subsequence of n consecutive symbols within the j consecutive symbols.

14. The image-recording device of claim 1 wherein the distance component additionally records the distance t from the surface to the imaging component in an electronic memory or mass-storage device.

15. A method for determining a distance t to associate with a region of an image of an environment recorded by an image-recording device, the method comprising:
projecting, into the environment, an (n,d) reliable M*-sequence of symbols;
recording the image of the environment;
identifying j consecutive symbols reflected back to the imaging component from a surface in the environment, where j≧n;
detecting and correcting a misidentified symbol within the j consecutive symbols based on the minimum distance d of the (n,d) reliable M*-sequence;
determining a first position of the j consecutive symbols with respect to the image;
determining a second position of the j consecutive symbols in the M*-sequence of symbols; and
determining, the first and second position, a distance t from the surface to the imaging component.

16. The method claim 15 wherein determining, from the first and second position, a distance t from the surface to the image-recording device further includes:
determining, from a known geometry of, and relative positions of components within, the image-recording device, a base distance b along a base line from a first reference point associated with a projection component to a second reference point associated with an imaging component;
determining, from the known geometry of, and relative positions of components within, the image-recording device and from the first and second position, a projection angle P between a line of symbol projection from the first reference point to the surface in the environment and the base line and a camera angle C between a line of symbol reflection from the surface in the environment to the second reference point, and the base line; and
determining a distance t from the surface to the image-recording device as
$$t = \frac{b ( sin P ) ( sin C )}{sin ( P + C )} .$$

17. The method of claim 15 wherein detecting and correcting a misidentified symbol within the j consecutive symbols based on the minimum Hamming distance d of the (n,d) reliable M*-sequence further comprises:
determining, from a known geometry of, and relative positions of components within, the image-recording device, an M*-sequence projected by the projection component that includes symbols reflected back to the imaging component as the j consecutive symbols;
employing a syndrome decoder for a linear block code comprising codewords of length n corresponding to the M*-sequence to determine a most likely subsequence of n consecutive symbols within the M*-sequence corresponding to n consecutive symbols within the j consecutive symbols.

18. The method of claim 15 wherein detecting and correcting a misidentified symbol within the j consecutive symbols based on the minimum Hamming distance d of the (n,d) reliable M*-sequence further comprises:
determining, from a known geometry of, and relative positions of components within, the image-recording device, an M*-sequence projected by the projection component that includes symbols reflected back to the imaging component as the j consecutive symbols; and
determining, as a most likely subsequence of n consecutive symbols within the M*-sequence, a subsequence of n consecutive symbols within the M*-sequence closest in Hamming distance to a corresponding subsequence of n consecutive symbols within the j consecutive symbols.

19. A distance-measuring device comprising:
a projection component that projects, into an environment, an (n,d) reliable M*-sequence of symbols; and
a distance component that
identifies j consecutive symbols reflected back to the distance-measuring device from a surface in the environment, where j≧n,
detects and corrects a misidentified symbol within the j consecutive symbols based on the minimum Hamming distance d of the (n,d) reliable M*-sequence,
determines a first position of the j consecutive symbols reflected back to the distance-measuring device relative to a first reference point,
determines a second position of the j consecutive symbols in the M*-sequence of symbols relative to a second reference point,
determines, from the first and second position, a distance t from the surface to the distance-measuring device, and
records the distance t from the surface to the distance-measuring device in an electronic memory or mass-storage device.

20. The distance-measuring device of claim 19 wherein the distance component determines, from the first and second position, as distance t from the surface to the imaging component by:
determining, from a known geometry of, and relative positions of components within, the distance-measuring device, a base distance b along a base line from the first reference point to the second reference point;
determining, from a known geometry of, and relative positions of components within, the distance-measuring device and from the first and second position, an angle P between a line of symbol projection from the first reference point to the surface in the environment and the base line and an angle C between a line of symbol reflection from the surface in the environment to the second reference point and the base line; and
determining a distance t from the surface to the distance-measuring device as
$$t = \frac{b ( sin P ) ( sin C )}{sin ( P + C )} .$$
